(19) United States
(12) Patent Application Publication
(10) Pub. No.: US 2011/0136481 A1
(43) Pub. Date: Jun. 9, 2011

(54) APPARATUS AND METHOD FOR AUTOMATICALLY CHANGING TELEPHONY MODE IN PORTABLE TERMINAL

(75) Inventors: Min-Ho PARK, Seoul (KR); Jae-Woo LEE, Anyang-si (KR)

(73) Assignee: SAMSUNG ELECTRONICS CO. LTD., Suwon-si (KR)

(21) Appl. No.: 12/961,821

(22) Filed: Dec. 7, 2010

(30) Foreign Application Priority Data
Dec. 9, 2009 (KR) 10-2009-0122037

(51) Int. Cl. H04M 3/00

(52) U.S. Cl. 455/418

(57) ABSTRACT

An apparatus and method for automatically changing a telephony mode in a portable terminal is provided. The apparatus includes a mode changing unit. The mode changing unit determines a distance between the portable terminal and a user's body and changes the telephony mode using the determined distance.

### PRIORITY

This application claims the benefit under 35 U.S.C. §119 of a Korean patent application filed in the Korean Intellectual Property Office on Dec. 9, 2009 and assigned Serial No. 10-2009-0122037, the entire disclosure of which is hereby incorporated by reference.

### BACKGROUND OF THE INVENTION

1. Field of the Invention

The present invention relates to an apparatus and method for changing a telephony mode in a portable terminal. More particularly, the present invention relates to an apparatus and method for automatically changing the telephony mode into a receiver mode or speaker mode based on a distance between the portable terminal and a user's body.

2. Description of the Related Art

Recently, portable terminals are being widely used as necessities of modern persons without distinction of age and gender. Service providers and terminal manufacturers are competitively developing products (or services) for differentiation from other competitors.

For example, the portable terminals have been developed to be multimedia devices that include capability for phonebooks, games, a Short Message Service (SMS), Electronic (E)-mails, morning calls, Motion Picture Expert Group Audio Layer-3 (MP3), schedule managing functions, digital cameras, wireless Internet services to provide various services, and the like.

Recently, the portable terminals have evolved to provide a videotelephony function that enables a face-to-face conversation through display screens of the portable terminals.

The videotelephony function includes displaying another user on a display unit of the portable terminal and then performing a telephony connection with the other user through speaker mode.

A speaker mode, which is a speaker phone mode of the portable terminal, refers to a function that allows a user to talk via the portable terminal using a microphone and a speaker instead of a receiver.

The speaker mode is being increasingly used because it is a convenient function that allows a user to talk via the portable terminal without using his hands.

However, there is an inconvenience in that a user of a portable terminal has to directly enter a menu for changing the telephony mode in order to perform a telephony connection using the speaker mode.

That is, the user of the portable terminal has to change the telephony mode through a plurality of key inputs when the user needs to change the telephony mode from a conventional mode (receiver mode) to the speaker mode, and has to re-enter the menu for changing the telephony mode when changing the telephony mode from the speaker mode to the conventional mode again.

Accordingly, in order to address the above limitation in the portable terminal, an apparatus and method for automatically changing the telephony mode without re-entering the menu for changing the telephony mode are required.

### SUMMARY OF THE INVENTION

An aspect of the present invention is to address at least the above-mentioned problems and/or disadvantages and to provide at least the advantages below. Accordingly, an aspect of the present invention is to provide an apparatus and method for automatically changing a telephony mode in a portable terminal.

Another aspect of the present invention is to provide an apparatus and method for determining a telephony mode to be changed using sensing information.

Another aspect of the present invention is to provide an apparatus and method for determining a timing for changing a telephony mode based on a distance between a user's body and a portable terminal performing a telephony connection.

In accordance with an aspect of the present invention, an apparatus for automatically changing a telephony mode in a portable terminal is provided. The apparatus includes a mode changing unit for determining a distance between the portable terminal and a user's body and for changing the telephony mode using the determined distance.

In accordance with another aspect of the present invention, a method for automatically changing a telephony mode in a portable terminal is provided. The method includes determining a distance between the portable terminal and a user's body, and changing the telephony mode using the determined distance.

In accordance with another aspect of the present invention, an apparatus for automatically changing a telephony mode in a portable terminal is provided. The apparatus includes a mode changing unit including a sensing unit for acquiring information for determining a distance from a user's body; and a situation determination unit for determining the distance from the user's body using the information acquired by the sensing unit.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a portable terminal automatically changing a telephony mode according to an exemplary embodiment of the present invention;

FIG. 2 is a flowchart illustrating a process of changing a telephony mode in a portable terminal according to an exemplary embodiment of the present invention;

FIG. 3A is a diagram illustrating a process of changing a speaker mode into a receiver mode in a portable terminal according to an exemplary embodiment of the present invention; and

FIG. 3B is a diagram illustrating a process of changing a receiver mode into a speaker mode in a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Hereinafter an apparatus and method for automatically changing a telephony mode by determining a timing for changing the telephony mode based on a distance between a user's body and a portable terminal performing a telephony connection will be described.

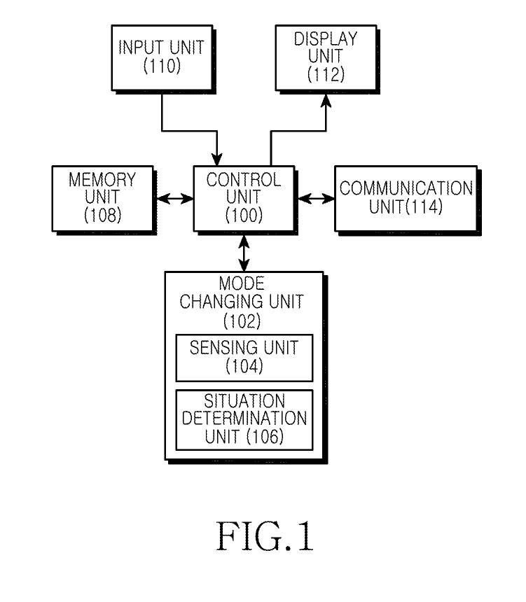

FIG. 1 is a block diagram illustrating a configuration of a portable terminal automatically changing a telephony mode according to an exemplary embodiment of the present invention.

Referring to FIG. 1, the portable terminal may include a control unit 100, a mode changing unit 102, a memory unit 108, an input unit 110, a display unit 112, and a communication unit 114. The mode changing unit 102 may include a sensing unit 104 and a situation determination unit 106. The portable terminal may include additional units that are not illustrated here merely for sake of clarity. Similarly, the functionality of two or more of the above units may be integrated into a single component.

The control unit 100 of the portable terminal controls overall operations of the portable terminal. For example, the control unit 100 performs processing and control for voice call and data communication, and changes the telephony mode by sensing a distance between the portable terminal and a user's body in addition to common functions.

That is, the control unit 100 may determine that a receiver mode is being used when a telephony connection is performed while the portable terminal approaches the user's body within a certain distance. On the other hand, the control unit 100 may determine that a speaker mode is being used when the telephony connection is performed while the portable terminal is distant from the user's body.

As described above, the control unit 100 may determine a timing for changing the telephony mode of the portable terminal, using a distance between the user's body and the portable terminal.

In an exemplary embodiment, the control unit 100 changes the telephony mode from the receiver mode to the speaker mode when the control unit 100 determines that the portable terminal becomes distant from the user's body during the telephony connection. The control unit 100 may determine that the portable terminal is distant from the user's body if the portable terminal is determined to be greater than a predetermined distance.

In contrast, the control unit 100 changes the telephony mode from the speaker mode to the receiver mode when the control unit 100 determines that the portable terminal approaches the user's body during the telephony connection. The control unit 100 may determine that the portable terminal is distant from the user's body if the portable terminal is determined to be less than or equal to a predetermined distance.

The mode changing unit 102 determines a time for changing the telephony mode using a distance between the portable terminal and the user's body under the control of the control unit 100.

That is, the mode changing unit 102 perceives the distance between the portable terminal and the user's body using sensing information acquired through the sensing unit 104, and allows the situation determination unit 106 to determine whether to perform a telephony mode of receiver mode or a telephony mode of speaker mode, using the perceived distance.

The sensing unit 104 includes a sensor acquiring the sensing information used in determining whether the user's body approaches, and acquires the sensing information for determining the distance from the user using the sensor.

The situation determination unit 106 determines the distance between the portable terminal and the user's body using the sensing information acquired by the sensing unit 104, and determines a timing for changing the telephony mode using a variation of the distance between the portable terminal and the user's body.

That is, the situation determination unit 106 may determine that the telephony mode has to be changed into a speaker mode to maintain the telephony connection in a state where the portable terminal is distant from the user's body when the situation determination unit 106 determines that the portable terminal which was adjacent to the user's body becomes distant from the user's body.

In contrast, the situation determination unit 106 may determine that the telephony mode has to be changed into a receiver mode by determining that the user cannot perform the speaker mode due to ambient noise when the situation determination unit 106 determines that the portable terminal (portable terminal performing a telephony connection of speaker mode) which was distant from the user's body becomes close to the user's body.

The memory unit 108 may include a Read Only Memory (ROM), a Random Access Memory (RAM), a flash ROM, and the like. The ROM stores various reference data and microcodes of programs for processing and controlling of the control unit 100 and the mode changing unit 102.

The RAM, which is a working memory of the control unit 100, stores temporary data generated during performance of various programs. Also, the flash ROM stores various renewable archival data such as telephone numbers, sent messages, and received messages.

The input unit 110 includes number key buttons from 0 to 9, a button, a cancel button, a check button, a send button, an end button, an Internet connection button, navigation key (or arrow key) buttons, character keys, a plurality of function keys, and the like. The input unit 110 provides key input data corresponding to a key pushed by a user to the control unit 100.

The display unit 112 displays state information, characters, videos, and still images generated during the operation of the portable terminal. The display unit 112 may use a color Liquid Crystal Display (LCD) device, and includes a touch input device that is used as an input device in a portable terminal of touch input type.

The communication unit 114 performs a function of transmitting/receiving radio signals of data inputted/outputted through an antenna (not illustrated). For example, upon transmission, the communication unit 114 codes and spreads data to be transmitted, and then perform a Radio Frequency (RF)-processing on the data to transmit. Upon reception, the communication unit 114 converts a received RF signal into a baseband signal, and despreads the baseband signal and performs a channel decoding to restore data.

Although the mode changing unit 102 may be substituted by the control unit 100 of the portable terminal, the mode changing unit 102 is separately provided in the present disclosure as an exemplary configuration for convenience of explanation without restricting the scope of the present invention. It will be apparent to those skilled in the art that various modifications can be implemented within the scope of the present invention. For example, all or any combination of the functions describe above may be processed in the control unit 100.

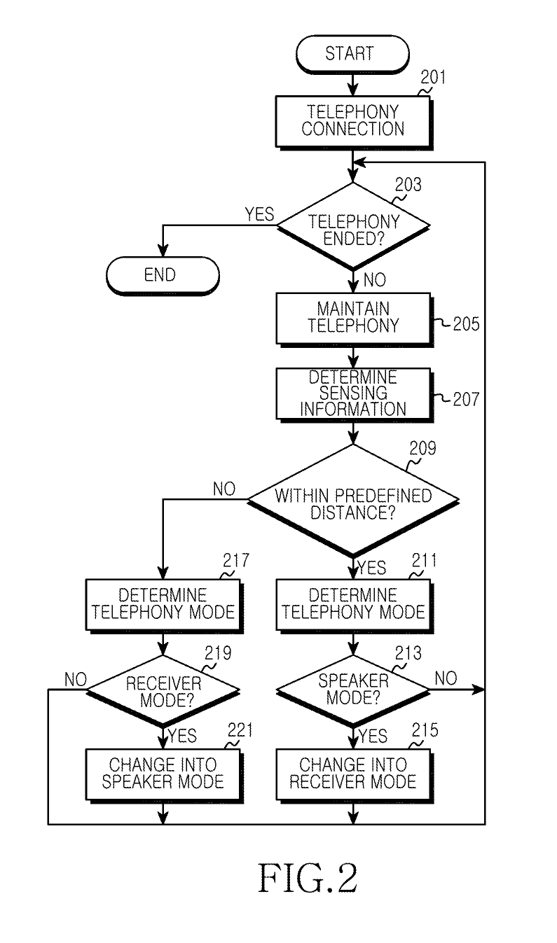

FIG. 2 is a flowchart illustrating a process of changing a telephony mode in a portable terminal according to an exemplary embodiment of the present invention.

Referring to FIG. 2, the portable terminal performs a telephony connection with another user in step 201, and then determines whether the telephony connection that is being performed ends in step 203.

If it is determined in step 203 that the telephony connection that is being performed does not end, the portable terminal maintains the telephone connection that is being connected in step 205.

Thereafter, the portable terminal determines sensing information for determining whether to change the telephone mode in step 207.

In an exemplary embodiment, the portable terminal may use a sensor that can determine a distance between the portable terminal and the user's body to change the receiver mode (in which a user talks over the telephone by locating the portable terminal at his ear) and the speaker mode (in which a user talks with another user through a speaker). That is, if the portable terminal determines that the distance between the portable terminal and the user's body is greater than a threshold, the portable terminal may determine that the user intends to share conversation with other persons or to talk over the portable terminal without grasping the portable terminal, and may change the telephony mode into the speaker mode. Also, if the portable terminal determines that the distance between the portable terminal and the user's body falls within the threshold, the portable terminal may determine that the user is located at a place where the speaker mode is not possible to perform, and may change the telephony mode into the receiver mode.

Using the sensing information determined in step 207, the portable terminal determines whether the distance between the portable terminal and the user's body falls outside the threshold in step 209.

That is, the portable terminal determines in step 209 whether sensing information for determining whether the distance between the portable terminal and the user's body falls within the threshold is acquired, or sensing information for determining whether the distance between the portable terminal and the user's body falls outside the threshold is acquired.

If the need for the mode change is determined in step 209 (determined that the portable terminal approaches the user's body to change the telephony mode into the receiver mode), the portable terminal determines a telephony mode that is being currently performed, and then determines whether the telephony mode determined is the speaker mode or not in step 213.

If the telephony mode is determined to be the speaker mode in step 213, the portable terminal changes the telephony mode into the receiver mode in step 215.

On the other hand, if the telephony mode is determined to be the receiver mode in step 213, the portable terminal maintains the receiver mode that is being performed and returns to step 203.

Thereafter, the portable terminal repeats the above processes until the telephony connection that is being currently set ends in step 203.

On the other hand, if the need for the mode change is not determined in step 209 (determined that the portable terminal becomes distant from the user's body by the threshold or more to change the telephony mode into the speaker mode), the portable terminal determines the telephony mode that is being currently performed, and then determines whether the telephony mode determined is a receiver mode or not in step 219.

If the telephony mode is determined to be the receiver mode in step 219, the portable terminal determines that the user has moved the portable terminal away from the user's body to use the speaker mode, and changes the receiver mode that is being performed into the speaker mode in step 221.

On the other hand, if the telephony mode is determined to be the speaker mode in step 219, the portable terminal maintains the speaker mode that is being currently performed and returns to step 203.

Thereafter, the portable terminal repeats the above processes until the telephony connection that is being set is ended in step 203.

That is, the portable terminal ends the present algorithm when determining the telephony connection is ended in step 203.

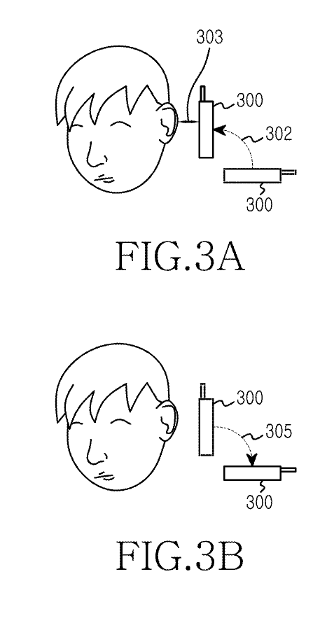

FIGS. 3A and 3B is a diagram illustrating a process of changing the telephony mode in a portable terminal according to an exemplary embodiment of the present invention.

FIG. 3A is a diagram illustrating a process of changing a speaker mode into a receiver mode in a portable terminal according to an exemplary embodiment of the present invention.

Referring to FIG. 3A, the portable terminal 300 may automatically change the telephony mode according to a distance 303 from a user's body. That is, the portable terminal 300 may change the telephony mode from the receiver mode to the speaker mode when the portable terminal becomes distant from the user's body during a telephony connection, and may change the telephony mode form the speaker mode to the receiver mode when the portable terminal approaches the user's body.

Thus, the user of the portable terminal may move the portable terminal 300 operating in the speaker mode to the user's body (ear) via movement 302 when conversation in the speaker mode is not possible due to ambient noise.

When the portable terminal 300 determines that the portable terminal 300 approaches the user's body through sensing information corresponding to distance 303 during the telephony connection (303), the telephony mode of the portable terminal 300 is changed from the speaker mode to the receiver mode.

The change from speaker mode to receiver mode may occur in a situation in which a user holds the portable terminal 300 to his ear as the user can hardly hear another user due to ambient noise during a telephony connection of speaker mode like a videotelephony.

FIG. 3B is a diagram illustrating a process of changing receiver a mode into a speaker mode in a portable terminal according to an exemplary embodiment of the present invention.

Referring to FIG. 3B, the portable terminal 300 may automatically change the telephony mode according to the distance from the user's body as described above.

When the user of the portable terminal 300 intends to share conversation with ambient persons or to talk over the portable terminal without grasping the portable terminal 300 during a telephony in the receiver mode, the user may change the telephony mode into the speaker mode by putting the portable terminal operating in the receiver mode away from the user's body (ear) by a threshold or more in the movement 305.

When the portable terminal 300 determines that the portable terminal 300 becomes distant from the user's body through the sensing information while maintaining the telephony connection, the telephony mode of the portable terminal may be changed from the receiver mode to the speaker mode.

The change from the receiver mode to the speaker mode may occur in a situation in which the telephony mode is changed into the speaker mode by putting the portable terminal on a desk to talk via the portable terminal while sharing conversation with another user with other ambient persons during the telephony connection via the portable terminal.

As described above, exemplary embodiments of the present invention relates an apparatus and method for automatically changing the telephony mode of a portable terminal using a distance between the portable terminal and a user's body. When the portable terminal becomes distant from the user's body during a telephony connection, the telephony mode may be changed into the speaker mode. When the portable terminal approaches the user's body during the telephony connection, the telephony mode may be changed into the receiver mode. Thus, an inconvenience that a user has to enter a telephony mode changing menu in a typical portable terminal can be addressed.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for automatically changing a telephony mode in a portable terminal, the apparatus comprising:
a mode changing unit for determining a distance between the portable terminal and a user's body and for changing the telephony mode using the determined distance.

2. The apparatus of claim 1, wherein the mode changing unit determines whether the portable terminal approaches the user's body or becomes distant from the user's body during a telephony connection.

3. The apparatus of claim 1, wherein the mode changing unit determines that the portable terminal operates in a receiver mode when the portable terminal performs the telephony connection in a state where the portable terminal is adjacent to the user's body.

4. The apparatus of claim 1, wherein the mode changing unit determines that the portable terminal operates in a speaker mode when the portable terminal performs the telephony connection in a state where the portable terminal is distant from the user's body.

5. The apparatus of claim 1, wherein the mode changing unit changes the telephony mode into a receiver mode when the portable terminal approaches the user's body during the telephony connection.

6. The apparatus of claim 1, wherein the mode changing unit changes the telephony mode into a speaker mode when the portable terminal becomes distant from the user's body during the telephony connection.

7. The apparatus of claim 1, wherein the mode changing unit determines the distance between the portable terminal and the user's body using sensing information capable of determining the distance to the user's body.

8. A method for automatically changing telephony mode in a portable terminal, the method comprising:
determining a distance between the portable terminal and a user's body; and
changing the telephony mode using the determined distance.

9. The method of claim 8, wherein the determining of the distance between the portable terminal and the user's body comprises:
determining whether the portable terminal approaches the user's body during a telephony connection; and
determining whether the portable terminal becomes distant from the user's body.

10. The method of claim 8, wherein the determining of the distance between the portable terminal and the user's body comprises determining that the portable terminal operates in a receiver mode when the portable terminal performs a telephony connection in a state where the portable terminal is adjacent to the user's body.

11. The method of claim 8, wherein the determining of the distance between the portable terminal and the user's body comprises determining that the portable terminal operates in a speaker mode when the portable terminal performs a telephony connection in a state where the portable terminal is distant from the user's body.

12. The method of claim 8, wherein the changing of the telephony mode comprises changing the telephony mode into a receiver mode when the portable terminal approaches the user's body during a telephony connection.

13. The method of claim 8, wherein the changing of the telephony mode comprises changing the telephony mode into a speaker mode when the portable terminal becomes distant from the user's body during a telephony connection.

14. The method of claim 8, wherein the determining of the distance between the portable terminal and the user's body comprising using sensing information capable of determining the distance to the user's body.

15. An apparatus for automatically changing telephony mode in a portable terminal, the apparatus comprising a mode changing unit comprising:
a sensing unit for acquiring information for determining a distance from a user's body; and
a situation determination unit for determining the distance from the user's body using the information acquired by the sensing unit.

16. The apparatus of claim 15, wherein the mode changing unit changes the telephony mode according to a determination result of the situation determination unit.

17. The apparatus of claim 15, wherein the situation determination unit allow the portable terminal to operate in a receiver mode when a telephony connection is performed in a state where the portable terminal is adjacent to the user's body, and allows the portable terminal to operate in a speaker mode when the telephony connection is performed in a state where the portable terminal is distant from the user's body.
